(19) United States
(12) Patent Application Publication
(10) Pub. No.: US 2008/0243681 A1
(43) Pub. Date: Oct. 2, 2008

(54) METHOD AND SYSTEM FOR ON-LINE CUSTOMER SCREENING

(75) Inventors: Shmarya Levin, Lincolnwood, IL (US); Jeffrey Mermelstein, Lincolnwood, IL (US)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(73) Assignee: REAL ID, INC., Lincolnwood, IL (US)

(21) Appl. No.: 12/051,576

(22) Filed: Mar. 19, 2008

Related U.S. Application Data
(60) Provisional application No. 60/908,009, filed on Mar. 26, 2007.

(51) Int. Cl. G06Q 40/00

(52) U.S. Cl. 705/38

(57) ABSTRACT

In one embodiment of the present invention there is provided a computer implemented method for pre-qualifying a customer interested in leasing an item owned by a third party, when the item is listed on an on-line database. The method includes receiving credit information related to said customer; retrieving decision criteria stored on a database and corresponding to said item; comparing the credit information to the decision criteria; generating an acceptance notice, when the credit information passes the decision criteria, or generating a declination notice, when the credit information fails the decision criteria; and sending the acceptance notice or declination notice to the customer and the third party.

### CROSS REFERENCE TO RELATED APPLICATIONS

The present invention claims the benefit of U.S. Provisional Application 60/908,009.

### FIELD OF THE INVENTION

The present invention relates to customer screening and more particularly to screening potential on-line customers.

### BACKGROUND OF THE INVENTION

One purpose of the present invention is to streamline and create an added value to online rental and advertising agencies by being able to screen potential on-line customers. The invention allows third parties to identify the potential customer as being capable of applying or qualifying for purchasing, renting, mortgaging, or leasing a selected item or items. Target industries for the present invention, include but are not limited to: Lending—for the purpose of obtaining a mortgage, home equity line of credit, automotive loans, student loans, etc.; Insurance—for the purpose of obtaining insurance for Real and Personal Property, Automotive, etc.; Utilities—for the purpose of obtaining a utility account for telephone, electricity, gas, etc.; and Rental—for the purpose of obtaining a residential or commercial lease, personal property rental, and similar luxury rental items. In addition, for purposes of the invention, the items may include rental properties, cars, homes, and other luxury items.

Typically, the customer when on-line may have the ability to view the items but the ability to actually be prescreened or qualified typically is only done when the customer actual contacts the owner and/or representative of the items. Therefore, general websites that list multiple items owned by different owners do not screen customers. The owners at that point must deal with any interested customer even if the customer is not able to purchase, lease, rent, or qualify for the item in question. It becomes a much more expensive task for the owners. If such prescreening or prequalification can be passed on to the customer or done at an earlier stage, the owners and customers will save time, energy, and most importantly money.

### SUMMARY OF THE INVENTION

In one embodiment of the present invention there is provided a computer implemented method for pre-qualifying a customer interested in leasing an item owned by a third party, when the item is listed on an on-line database. The method includes receiving credit information related to said customer; retrieving decision criteria stored on a database and corresponding to said item; comparing the credit information to the decision criteria; generating an acceptance notice, when the credit information passes the decision criteria, or generating a declination notice, when the credit information fails the decision criteria; and sending the acceptance notice or declination notice to the customer and the third party.

The embodiment may also include receiving personal information from the customer and storing said personal information as a profile on a database for later retrieval. In addition, the step of receiving credit information related to the customer may further include obtaining the profile from the database and obtaining an on-line Credit Report related to the customer based on the profile. In addition, the method may also include posting the Credit Report to the customer.

In another embodiment, there may be provided a method for pre-qualifying a customer interested in leasing or purchasing an item owned by a merchant, when the item is posted on a first party website. The method may include the following steps: receiving a request to pre-qualify the customer for leasing or purchasing the item; redirecting the customer to a second party website, the second party website having an application form to obtain personal information from the customer; obtaining credit information related to the customer and based on the personal information entered into the application form; accessing a decision criteria stored on a second party database; comparing the credit information to the decision criteria; generating an acceptance notice, when the credit information passes the decision criteria, or generating a declination notice, when the credit information fails the decision criteria; sending the acceptance notice or declination notice to the customer and the merchant; and redirecting the customer back to the first party website.

In addition, the request to pre-qualify the customer for leasing or purchasing the item may include a unique identification number associating the item to specific decision criteria such that the step of accessing the decision criteria would access the specific decision criteria corresponding to the item. Yet further, the request to pre-qualify the customer for leasing or purchasing the item may include a unique first party website identification to help send the customer back to the correct first party website at the end of the pre-qualification.

The step of obtaining credit information related to the customer and based on the personal information may require accessing a third party website for obtaining a Credit Report. And may further allow the customer to view the Credit Report if the customer has a stored profile.

In addition, the step of accessing the decision criteria stored on a second party database includes identifying a specific decision criteria relating to the item from a plurality of pre-stored decision criteria corresponding to a plurality of items. Pre-steps could also be provided to a merchant allowing access to the second party database to create a decision criteria corresponding to an item.

Numerous other advantages and features of the invention will become readily apparent from the following detailed description of the invention and the embodiments thereof, from the claims, and from the accompanying drawings.

### DESCRIPTION OF THE DRAWINGS

A fuller understanding of the foregoing may be had by reference to the accompanying drawings, wherein:

FIG. 1 is a flow chart of the prior art method;

FIGS. 2 and 3 are flow charts of one embodiment of the present invention; and

FIG. 4 is a flow chart displaying the internal relationship between the online service provider and the system in accordance with an embodiment.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

There present invention is preferably done on-line through a website. Therefore, computer systems, global communication database, servers, user sites, and various other peripherals well known in the industry are employed in the present invention and such items do not need further clarification or identification for the present invention. The present invention is also software related in that the steps used to accomplish the tasks are functions running on a computer/server either at website being viewed by the user or running at a host site accessible by the website. In either instance, the software may also access outside or third party information databases in order to download, upload, verify, or check information.

In one embodiment of the present invention, a method is employed with the various steps as outlined herein. The embodiment was performed towards a specific item, renting properties such as apartments or houses; however, the item may be changed without affecting the scope of the invention.

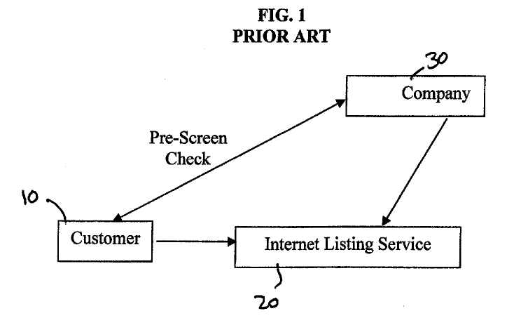

Referring to FIG. 1, in the prior art, the Customer 10 could review listings or various items on-line 20. But when the Customer 10 is interested in a particular item, the Company or Owner of the Item 30 would have to contact the Customer 10. The Customer 10 would have to either submit an application and/or submit to pre-screen credit check. The Company 30 in these instances spends time, effort, and money on this process. The present invention solves this problem.

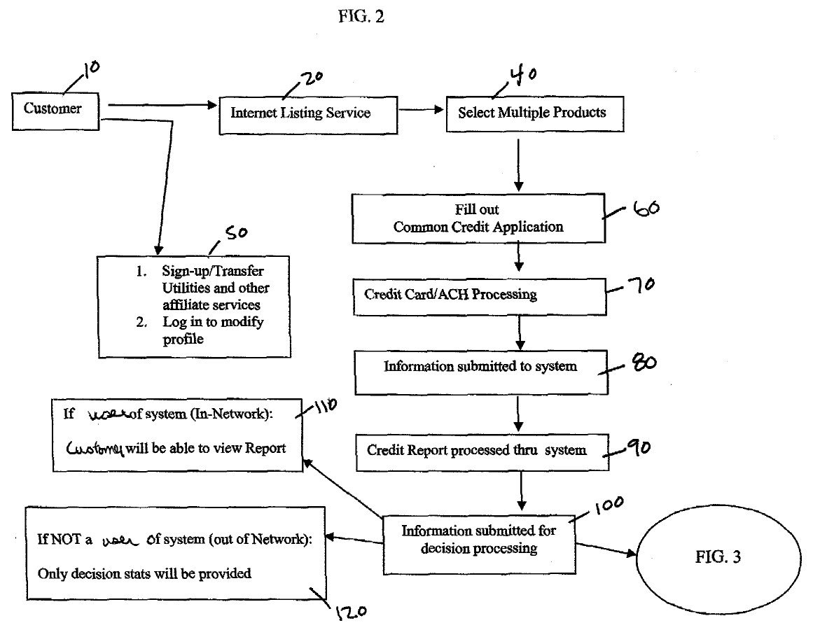

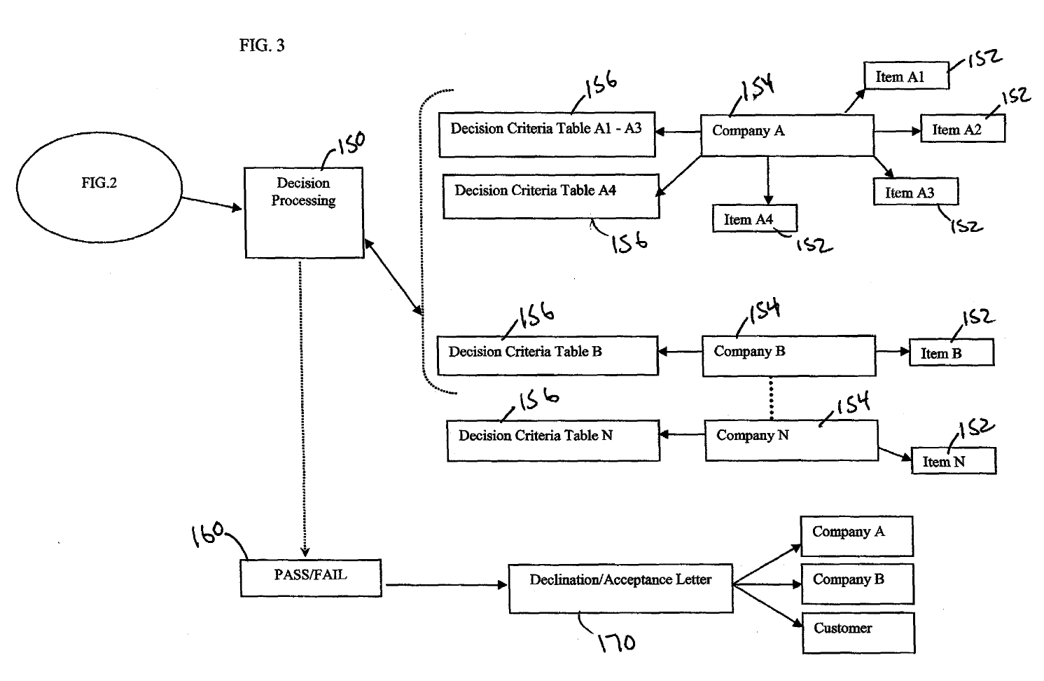

Referring to FIGS. 2 and 3, in one embodiment the Customer 10 may sign-up 50 to create a profile with the system. This may help if the Customer is looking at numerous items or is a repeat consumer.

The Members 15, typically management companies or owners of various items, are given access to a main host server which tracks the Member's criterion. The Member has the ability to utilize basic, advanced, or customized decision tables 17 for pre-screening the Customers. The decision tables 17 which are typically unique to a Member 15 may be based on the following criteria.

Basic—Preset decision packages based on national statistics

Advanced—ability to define multiple field requirements to accept/decline prospective tenants (example: minimum FICO score, number of trade lines, overall balance ratios, required gross/net income, etc.)

Customized—Decision criterion based on item (ie. 1/2/3 bedroom requiring variations of FICO score, income, etc.). In addition, the customized decision criterion will have the ability to select basic or advanced, similar to the above.

Once the criterion is entered by the Member, the Member will list properties or items on a website dedicate to listing such properties or items. The website may have a national listing or local listing or both. It may also be opened to numerous Members or may be dedicate to only items made available by the Member.

A user or potential customer will then access the website. The Customer 10 is able to review listings of items on-line 20. The Customer 10 may also select one or more items or products 40 for pre-screening.

The website may have its own search and sorting capabilities that allows the user to identify properties they are interested in seeing or obtaining additional information. At this point, (in the past and in the prior art) the user is typically given a phone number or email in order to contact the owner or management company handling the property. As mentioned above, the management company must then prescreen or qualify the user to make a determination whether the user is capable of renting the property. The present invention, however, is employed to help or remove this step from the management company.

The user in the present embodiment, will have the ability to browse rental properties in specified geographical areas. Next to each advertising property, a small checkbox will provide the user with the ability to apply to the specified properties. The system allows the user to apply from one to multiple properties simultaneously.

Once the item(s) are selected, the Customer may be required to fill out a credit application 60 on-line. In other embodiments, the information may have been provided in the profile creation 50, at which point, this step 60, may only be an authorization to proceed with the credit application 60. Authorization may include the Customer to digitally sign the authorization for release of personal credit information, as required under the FCRA. The system will maintain these digital authorizations in the event of an audit.

The system may now process a credit card charge/ACH processing relating to the pre-screen check 70. Such fees may be standard rates for applying to a given number of properties; as these may vary. While not included in the illustrating, the system may include steps relating to a credit card charge being rejected. Allowing the Customer to enter other credit card or other forms of payment, such as but not including, direct bank debit charge, or on-line payments.

With the profile information, application information, and/or the credit card charge being accepted 80, the system may process a Credit Report 90 or credit information. The system to process a Credit Report or credit information would connect to various other third party informational databases to pull the necessary credit report or other information. Once the Credit Report or credit information is obtained, the system will begin to prepare the Credit Report or credit information needed from the Credit Report for the decision processing 100. In addition, if the Customer or Member may or may not be able to view the Credit Report, 110 and 120 respectively.

With the Credit Report or credit information along with any additional information asked and received from the Customer (referred to as the decision information), the system can begin the decision processing 150. The decision processing compares the decision information against the decision criteria for each selected item.

As illustrated each item 152 is owned by a Company 154. Moreover, each item 152 is also related to a Decision Criteria 156, such that it is possible that a Company 154 owns multiple listed Items 152 and uses one or more Decision Criterions 156 for the multiple listed Items. As shown in FIG. 3, Company A has listed 4 items and uses two decision criterions; Company B has a single item listed and would only have a single decision criteria. This can continue for any number of companies, items, and decisions. In this example, the Customer has selected items Al through A4 and item B. The system will check the decision information against the two decision criterions related to items Al through A4 and the decision criteria related to item B. It is also possible that Company A has additional items, Item A5 . . . Item An which were not selected for the comparison by the Customer.

As mentioned, for each item selected the system will determine if the Customer passed or failed the decision criteria 160. Upon completion of the decision processing, the system will automatically generate one of two documents 170, as per the FCRA guidelines, either a declination Letter or an Acceptance Letter. The letter listing the accepted properties or Declination form listing the declined properties. Alternatively, separate letters can be generated for each item. The Companies affiliated with a selected item, along with the Customer, would be allowed to review the letters; and may in some embodiments only allowed to review letters related to the selected item.

The Companies that are members to the system will have the ability to view the accepted and declined information (not credit). In addition, the system will provide contact information for all those that have been accepted and declined to their property. Lastly, managers can create customizable graphs and reporting statistics within the system to identify the number of potential applicants versus declinations and acceptances.

At any time, a management company may sign up for additional services with the host of the system. Such additional services may allow the management company to view selected credit reports for accepted or declined applicants; and may include the ability to screen against criminal searches, eviction searches, and other public information searches and reports.

Upon receipt of the “Welcome Letter” to the accepted item(s), the user will have the ability to have their information sent directly to other participants in the system including moving company, utilities, etc. Thereby, if the user elects to move within a certain period of time, the moving company will receive a scheduled pickup from the current location to move, on time, to the new apartment. For the utilities, the utility companies will receive all the necessary information to have the new account all set up prior to moving in.

In addition, the system may elect to create a standardized credit scoring model. This would provide more product uniqueness. The system will also be created to allow for ultimate integration and for constant change based on customer/client demand.

There are a number of advantages from the present system. These include:

Customer Advantages include Apply to multiple apartment sites simultaneously; Know where accepted; Reduced feeling of rejection; Reduced cost of application fees; Reduces time to finding an apartment or item; and One credit inquiry→reduced negative effect from credit inquiry.

Management Co. Advantages include One stop shop for advertising and drawing rental applications; Increased traffic; Qualified traffic only; and Overall increased online presence.

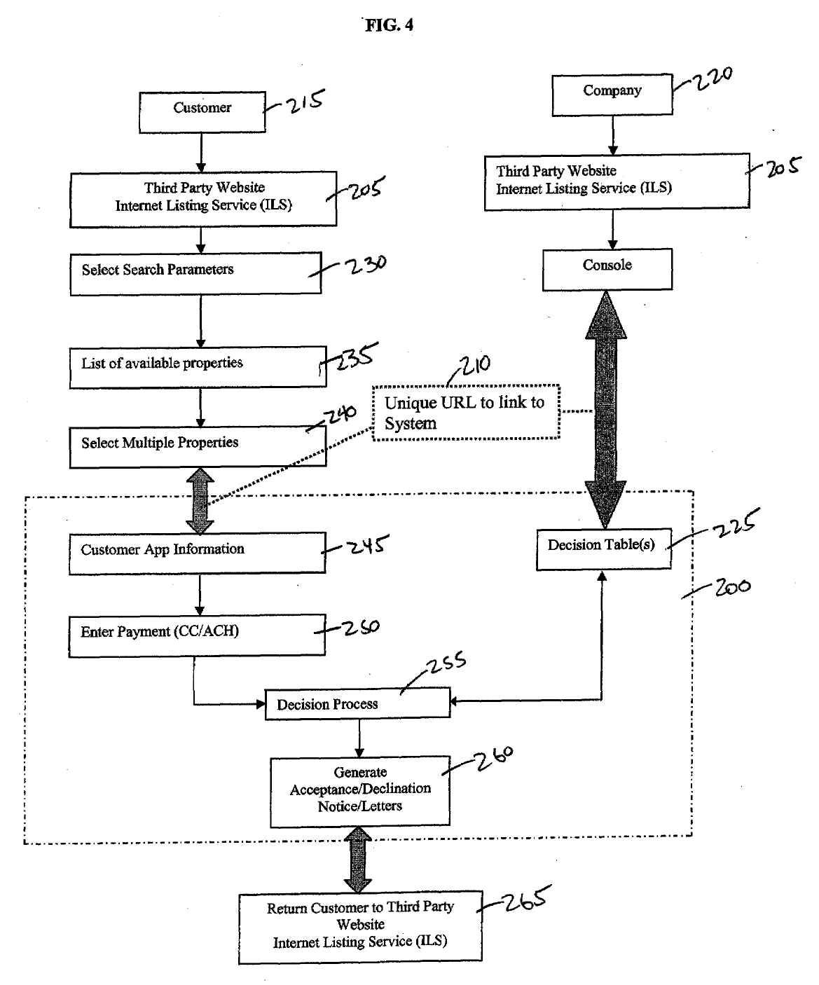

Referring now to FIG. 4, in another embodiment of the present invention the system 200 can be used with a third party website 205. This can be done using a unique URL query string 210 containing an associated property ID which relates to the property the Customer 215 is applying for and a referring URL to unique identify the third party website 205, from which the Customer 215 is accessing. Using these two keys the system 200 can identify where the requests are coming from and which property or properties the applicant has selected. Any additional information, such as the property image, description, contact information, etc., that is available can also be displayed during the application process. When linking a large amount of dynamically changing properties to the system, web service based queries can be established to pass information between the third party website and the system, so that large uploads of property information are not required. Standard exchanges for passing the information can be used, such as but not limited to SOAP/RPC/REST or direct POST/GET calls.

In one example of linking to the system with a single property would be to have the Company 220 embed an application URL along with the associated property ID into a link from the third party website 205. The URL for linking to the system can be in the format of http(s)://application.multiqualify.com/?property=<n> where <n> contains the ID number of a valid participating property within the third party's website, and for which the system has received an address and decision table information 225 for the ID number. Similarly, multiple properties can be applied for in a single request by linking to http(s)://application.multiqualify.com/?properties=<n1>,<n2>,<n3>.

If however, a decision table is not available for a specific selected property, the system 200 can create generic decision table elements based on states, counties, or other regional elements.

When the Customer 215 enters the third party website 205, the Customer, will be able to search 230 through listed 235 properties, and select 240 on link(s) established as defined above, the Customer will be automatically redirected to the system 200 which can even be branded using the third party logo, contact information and website link based on the referring URL. When a match is found for the referring URL and the property ID defined is a valid participating property for which a decision table is defined, the Customer will be led through several brief forms 245 to collect information about the Customer as well as payment information 250 for a report (if the Customer does not have a valid credit profile on file). Alternatively, the Customer can sign in to their existing credit profile which will be recalled and applied against the property's associated decision values for approval, conditional approval, and/or declination. At all times during the application process, the Customer will be able to click the property information link to jump directly back to property information at the third party website.

Based on the selected items, the credit information, other Customer information and the decision tables, the system will conduct a decision process 255 and generate acceptance/declination notices and/or letters 260. Afterwards, the Customer will be redirected back to the third part website 265 and provided additional information to set up appointments if the Customer was accepted.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

We claim:

1. A computer implemented method for pre-qualifying a customer interested in leasing an item owned by a third party, when the item is listed on an on-line database, the method comprising:
receiving credit information related to said customer;
retrieving decision criteria stored on a database and corresponding to said item;
comparing the credit information to the decision criteria;
generating an acceptance notice, when the credit information passes the decision criteria, or generating a declination notice, when the credit information fails the decision criteria; and
sending the acceptance notice or declination notice to the customer and the third party.

2. The method of claim 1 further including receiving personal information from the customer and storing said personal information as a profile on a database.

3. The method of claim 2, wherein the step of receiving credit information related to said customer, further includes obtaining said profile from said database and obtaining an on-line Credit Report related to said customer based on said profile.

4. The method of claim 3 further including posting said Credit Report to said customer.

5. A method for pre-qualifying a customer interested in leasing or purchasing an item owned by a merchant, when the item is posted on a first party website, the method comprising:
receiving a request to pre-qualify the customer for leasing or purchasing said item;
redirecting the customer to a second party website, the second party website having an application form to obtain personal information from the customer;
obtaining credit information related to said customer and based on said personal information;
accessing a decision criteria stored on a second party database;
comparing the credit information to the decision criteria;
generating an acceptance notice, when the credit information passes the decision criteria, or generating a declination notice, when the credit information fails the decision criteria; and
sending the acceptance notice or declination notice to the customer and the merchant; and
redirecting the customer back to the first party website.

6. The method of claim 5, wherein the request to pre-qualify the customer for leasing or purchasing said item includes a unique identification number associating the item to a specific decision criteria such that the step of accessing the decision criteria would access the specific decision criteria corresponding to said item.

7. The method of claim 5, wherein the request to pre-qualify the customer for leasing or purchasing said item includes a unique first party website identification.

8. The method of claim 5, wherein the step of obtaining credit information related to said customer and based on said personal information includes accessing a third party website for obtaining a Credit Report.

9. The method of claim 5, wherein the step of accessing the decision criteria stored on a second party database includes identifying a specific decision criteria relating to said item from a plurality of pre-stored decision criteria corresponding to a plurality of items.

10. The method of claim 5 further including the pre-steps of providing a merchant with access to the second party database to create a decision criteria corresponding to an item.

11. The method of claim 5 further including the step of storing a profile of the customer of a database containing a plurality of profiles.
